(19) United States
(12) Patent Application Publication
(10) Pub. No.: US 2013/0046878 A1
(43) Pub. Date: Feb. 21, 2013

(54) ASYNCHRONOUS REQUEST INTERCEPTION FOR TESTING A REQUEST LIFE-CYCLE

(71) Applicants: Lukas Fryc, (US); Ondrei Zizka, (US)

(72) Inventors: Lukas Fryc, (US); Ondrei Zizka, (US)

(21) Appl. No.: 13/209,848

(22) Filed: Aug. 15, 2011

(51) Int. Cl. G06F 15/173

(52) U.S. Cl. 709/224

(57) ABSTRACT

Methods and systems for asynchronous request interception for testing a request life-cycle are described. In one embodiment, a proxy object intercepts an asynchronous request directed to an original object used to implement a network communication interface for an application, having a client-side application and a server-side application. The proxy object is configured to allow a test entity to verify the application during a request life-cycle of the asynchronous request. The proxy object gives control to the test entity and receives permission back to further process the asynchronous request. The proxy object sends the asynchronous request to the original object when the permission is received.

### TECHNICAL FIELD

Embodiments of the present invention relate to testing asynchronous requests, and more specifically, to asynchronous request interception for testing a request life-cycle.

### BACKGROUND

A rich Internet application (RIA) is a web application that has many characteristics of desktop application software. Typically, RIAs are delivered by a site-specific browser, a browser plug-in, virtual machines, or the like. Also, JavaScript-based alternatives, like Asynchronous for JavaScript and XML (AJAX) use built-in browser functionality to implement comparable interfaces. Due to the nature of web applications, some aspects of testing web applications can be difficult compared to desktop application software. For example, there is a need to verify output perceived by the user in a stable state of the web application, especially in RIAs. It is also necessary to test the application state during server requests. However, automated testing of asynchronous requests, such as AJAX requests, currently used in RIA, are difficult to test due to the non-deterministic timing of the asynchronous requests. Web frameworks, which will be reused in thousands of projects, often require exact testing of the application states during the request life-cycle.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of an exemplary network architecture in which embodiments of a proxy object may operate.

FIGS. 2A and 2B are sequence diagrams of embodiments of the proxy object of FIG. 1.

FIG. 3 is a flow diagram of one embodiment of a client-side method of asynchronous request interception.

FIG. 4 illustrates a diagrammatic representation of a machine in the exemplary form of a computing system for asynchronous request interception for testing a request life-cycle.

### DETAILED DESCRIPTION

Methods and systems for asynchronous request interception for testing a request life-cycle are described. In one embodiment, a proxy object intercepts an asynchronous request directed to an original object used to implement a network communication interface for an application, having a client-side application and a server-side application. The proxy object is configured to allow a test entity to verify the application during a request life-cycle of the asynchronous request. The proxy object gives control to the test entity and receives permission back to further process the asynchronous request. The proxy object sends the asynchronous request to the original object when the permission is received.

The embodiments described herein provide an improved system that allows asynchronous request interception using a proxy object. The proxy object intercepts asynchronous requests for testing the asynchronous request during the life-cycle of the XMLHttpRequest (XHR), for example. The proxy object gives control to a test entity to verify progress of request (e.g., visual representation of request on the page). The embodiments described herein may also be used to test advanced principles like client-side queues or parallel communication using two or more proxy XHR objects simultaneously. In some embodiments, the original and proxy objects are XHR objects. In other embodiments, the original and proxy objects are websockets objects. Alternatively, other original and proxy objects that are used to establish and maintain network communication interfaces may be used as would be appreciated by one of ordinary skill in the art having the benefit of this disclosure, such as other client-side communications that replace XHR or websockets.

In the following description, numerous details are set forth. It will be apparent, however, to one of ordinary skill in the art having the benefit of this disclosure, that embodiments of the present invention may be practiced without these specific details. In some instances, well-known structures and devices are shown in block diagram form, rather than in detail, in order to avoid obscuring the embodiments of the present invention.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving,” “intercepting,” “giving,” “generating,” “communicating,” “capturing,” “executing,” “defining,” “specifying,” “creating,” “recreating,” “processing,” “providing,” “computing,” “calculating,” “determining,” “displaying,” “detecting,” “sending,” or the like, refer to the actions and processes of a computing system, or similar electronic computing systems, that manipulates and transforms data represented as physical (e.g., electronic) quantities within the computing system's registers and memories into other data similarly represented as physical quantities within the computing system memories or registers or other such information storage, transmission or display devices.

Embodiments of the present invention also relate to an apparatus for performing the operations herein. This apparatus may be specially constructed for the required purposes, or it may comprise a general-purpose computing system specifically programmed by a computer program stored in the computing system. Such a computer program may be stored in a computer-readable storage medium, such as, but not limited to, any type of disk including optical disks, CD-ROMs, and magnetic-optical disks, read-only memories (ROMs), random access memories (RAMs), EPROMs, EEPROMs, magnetic or optical cards, or any type of media suitable for storing electronic instructions.

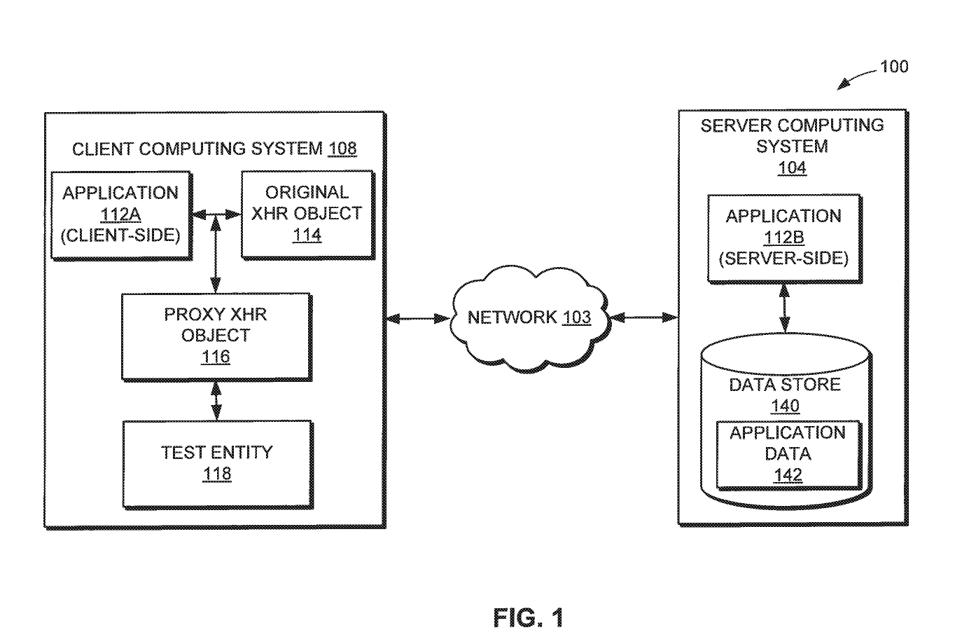

FIG. 1 is a block diagram of exemplary network architecture 100 in which embodiments of a proxy XMLHttpRequest (XHR) object 116 for asynchronous request interception may operate. The network architecture 100 may include a server computing system 104 and a client computing system 108, each connected via a network 103, which may be a private network (e.g., a local area network (LAN), wide area network (WAN), intranet, etc.) or a public network (e.g., the Internet). The client computing system 108 may be one or more machines, including a desktop computer, laptop computer, server, cellular phone, personal digital assistant (PDA), etc. In one embodiment, the client computing system 108 is a server of an enterprise, but is a “client” with respect to the server computing system 104, which may be another server in the enterprise network. The client computing system 108 interacts with the server computing system 104 by exchanging messages via standard protocols, e.g., HTTP and WebSockets.

In the depicted embodiment, the client computing system 108 executes an application 112A (client-side), an original XHR object 114, the proxy XHR object 116, and a test entity 118. The original XHR object 114 is an application programming interface (API) available in web browser scripting languages, such as JavaScript. The original XHR object 114 is used to implement a network communication interface between an client application 112A (client-side) and a server application 112B (server-side). In one embodiment, the client application 112A and the server application 112B form a web application, where the server-side application 112B represents the application on the server computing system 104 and can be accessed/viewed by a user via the client-side 112A. In one embodiment, the client application 112A is a browser. Alternatively, the client application 112A may be other applications that send asynchronous requests to the server computing system 104 as would be appreciated by one of ordinary skill in the art having the benefit of this disclosure.

The original XHR object 114 is configured to send asynchronous requests, such as Hypertext Transfer Protocol (HTTP) or HTTP Secure (HTTPS) requests, to a web server (e.g., application 112B (server-side)) and load the server response data directly back into the script. The response may be XML text, plain text, or the like, and can be used to alter the document object model (DOM) of the document in the browser window without loading a new web page document. The response data can also be further processed by client-side scripting, for example to convert the formatted server-side object to a client-side object for further use by the client computing system 108. The original XHR object 114 is also configured to request AJAX requests, such as for dynamic web applications. AJAX is a group of interrelated web development methods used on the client-side to create interactive web applications. With AJAX, web applications can send data to, and retrieve data from, the server computing system 104 asynchronously without interfering with the display and behavior of the existing web page. In the depicted embodiment, the client application 112A sends data to, and retrieves data from, the server computing system 104 using AJAX requests via the original XHR object 114. Interception of AJAX requests is based on the fact that support for this type of asynchronous communication is written in JavaScript (JS) language. The prototype-based nature of JS allows non-problematic interception of the asynchronous request by the object used for AJAX communication—XHR. An application that wants to communicate asynchronously, creates the original XHR object (or other objects used for creating and maintaining the network communication interface) and uses its methods in order to establish and maintain connection.

To allow for testing of the application, a proxy object can be used to extend the capabilities of the original XHR object 114. In this case of XHR objects, the proxy XHR object 116 is used. The proxy XHR object 116 allows for overriding of the original XHR object 114 to allow processing of testing code. Because XHR objects are implemented across browsers as native objects, and JS does not allow overriding of native object methods, it is not possible to rewrite the methods of the original XHR objects directly. However, JS, as a dynamic language, allows for redefinition of any reference to an object, including references to native objects. In order to override the XHR functionality, the client computing system 108 stores a reference to the original XHR object 114, and modifies the prototype (prototype inheritance) to create a new XHR object (called the proxy XHR object 116). The proxy XHR object 116 implements all of the methods of the original XHR object in order to operate like the original XHR object 114. The proxy XHR object 116 creates the original XHR object instance in constructor and defines all methods which the original XHR object has implemented. When the new proxy XHR object is created, a reference to the original XHR object is stored. The proxy XHR object 116 calls the original XHR object instance in all its methods. In this way, the original functionality is maintained, and the proxy XHR object 116 can extend the functionality by any additional code using prototype-based inheritance.

In the depicted embodiment, the client computing system 108 executes the proxy XHR object 116 to extend the capabilities of the original XHR object 114, and in particular, to allow the test entity 118 to intercept asynchronous requests and to verify the application 112 during request life-cycles of the asynchronous requests. The proxy XHR object 116 extends the original XHR object 114 to save attributes passed between the client application 112A and the server appreciation 112B when the proxy XHR object 116 is enabled. In one embodiment, the test entity 118 is configured to verify the progress of the asynchronous request.

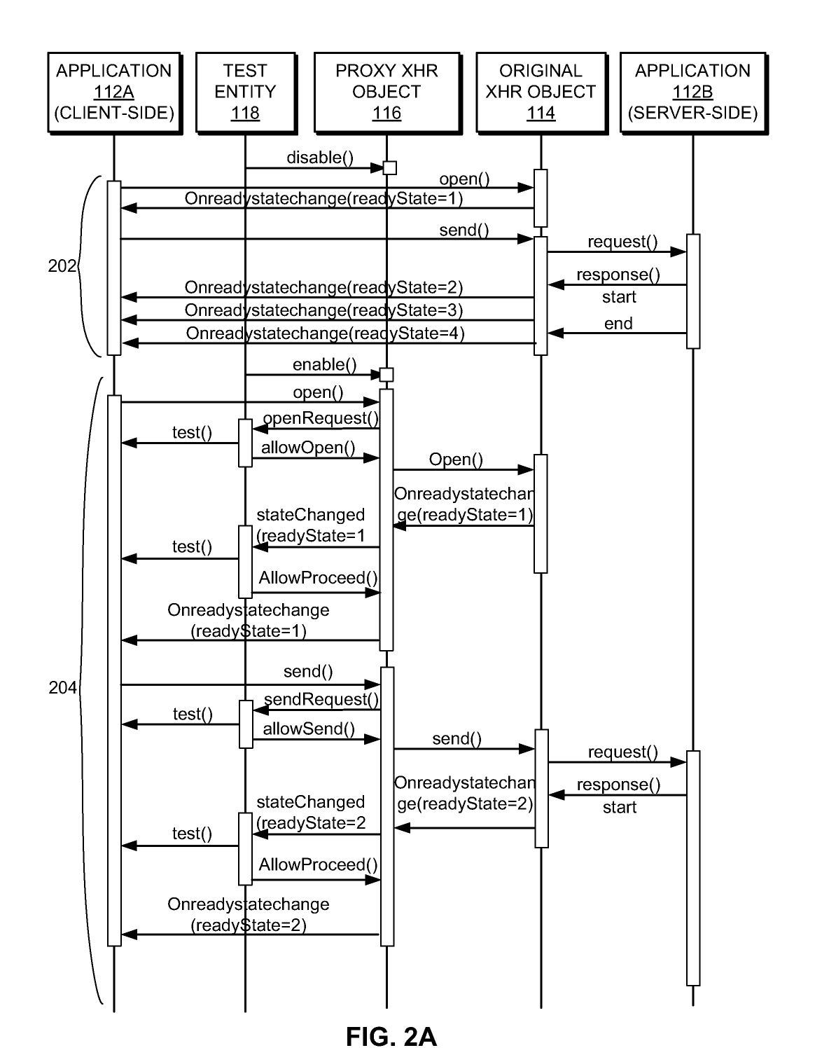

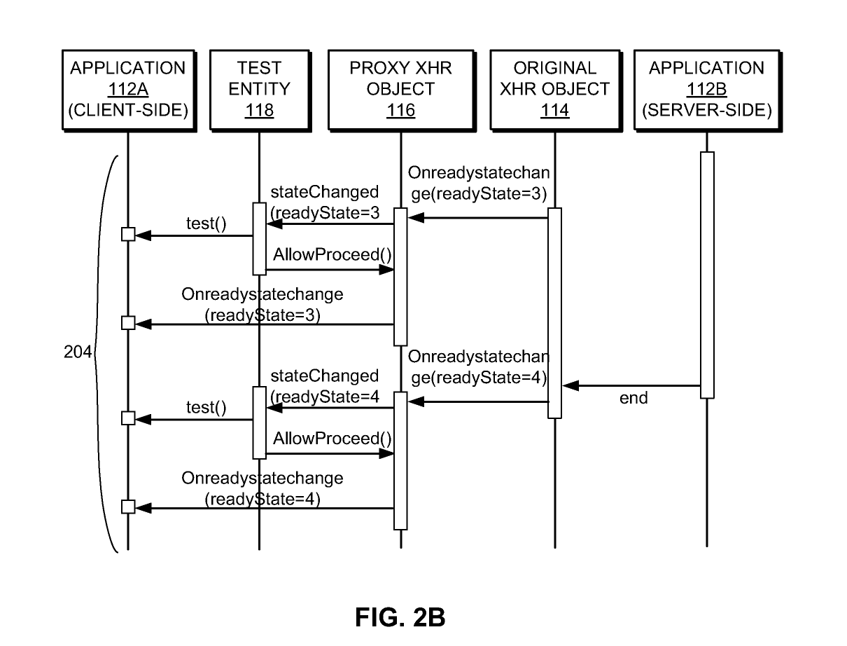

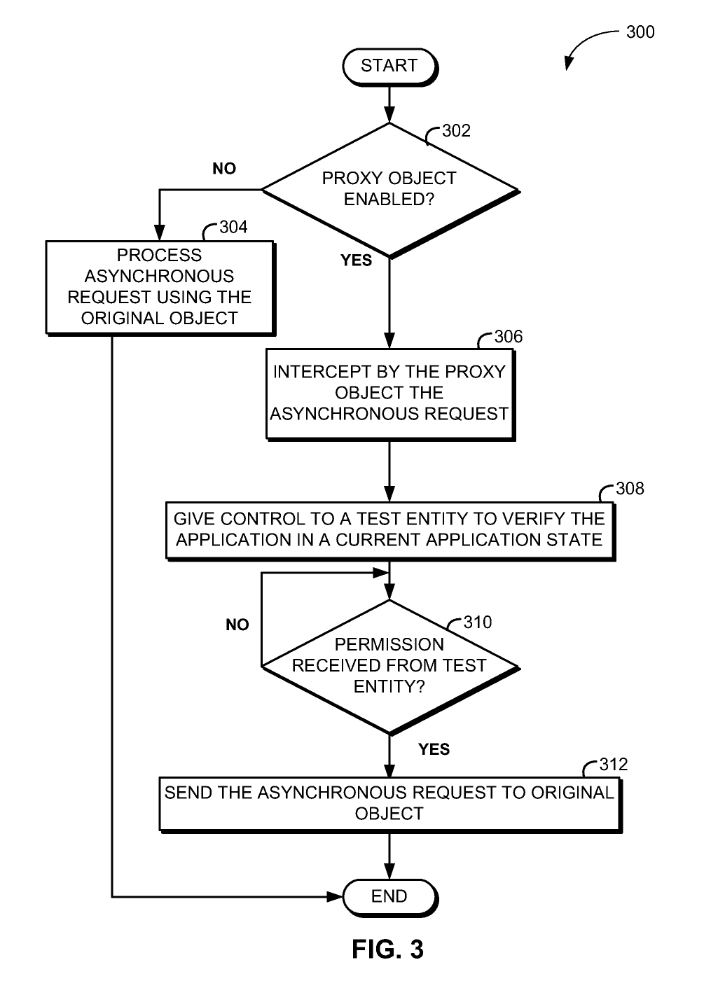

In one embodiment, the proxy XHR object 114 intercepts an asynchronous request directed to the original XHR object 114. Upon intercepting the request, the proxy XHR object 116 gives control to the test entity 118 to verify the application in a current application state. The test entity 118 performs testing of the application. When completed, the proxy XHR object 116 receive permission from the test entity 118 to further process the asynchronous request, and the proxy XHR object 116 sends the asynchronous request to the original XHR object 114 when the proxy XHR object 116 receives the permission. Although FIG. 1 illustrates and describes the original XHR object 114 and the proxy XHR object 116, in other embodiments, other original objects and proxy objects that are used to implement and maintain network communication interfaces may be used as would be appreciated by one of ordinary skill in the art having the benefit of this disclosure. In one embodiment, the original object is a websockets object, and the proxy object is a proxy websockets object. Websockets is a technology providing for bi-directional, full-duplex communication channels over a single Transmission Control Protocol (TCP) socket. Websockets can be used in web browsers and web servers, but may also be used by any client and server application, such as the application 112 described herein. Further details of the operations of the application, original XHR object 114, proxy XHR object 116, and test entity 118 are described below with respect to FIGS. 2A, 2B, and 3.

In another embodiment, the client computing system 108 includes a JS runtime machine to execute the client-side application 112A, the test entity 118, the proxy object 116, and the original object 114. The test entity 118 may be a JS test object configured to verify the current application state during the request life-cycle of the asynchronous request. In another embodiment, the test entity 118 is executed on another computing system.

The server computing system 104 may be one or more machines including one or more server computers, gateways, or other computing systems. The server computing system 104 hosts the application 112 (e.g., application 112B (server-side)) and may include a data store 140 that stores application data 142. The application 112 may be a process run on the server computing system 104 to perform one or more functions. In one embodiment, the application 112 is a web application that is accessed over the network 103. The server computing system 104 renders client-side code of the web application to the browser in a browser-controlled environment, or is coded in a browser-supported language (e.g., JavaScript, combined with a browser-rendered markup language like HTML) and reliant on a common web browser (e.g., client application 112A) to render the application executable.

The server computing system 104 may also include a local data store 140, which can be one or more centralized data repositories that store the application data 142, such as data used to execute the application 112, user data, configuration data, or the like. The local data store 140 may represent a single or multiple data structures (databases, repositories, files, etc.) residing on one or more mass storage devices, such as magnetic or optical storage based disks, tapes or hard drives. Although illustrated as being local to the server computing system 104, the local data store 140 may be remote from the server computing system 104 and the server computing system 104 can communicate with the remote data store over a public or private network, a bus, or the like.

FIGS. 2A and 2B are sequence diagrams of embodiments of the proxy object of FIG. 1. FIG. 2A illustrates a typical life-cycle 202 of an asynchronous request (AJAX) when the proxy XHR object 116 is disabled. The simplified life-cycle of the AJAX request can be conceptually divided into several steps: 1) the original XHR object 114 is created; 2) application's request event handler is registered on onreadystatechange property; 3) open() method is called on original XHR object 114; 4) send() method is called on original XHR object 114; 5) server-side application 112B processes the request and responds; 6) client-side application 112A obtains a response in the form of parameters of onreadystatechange function. This life-cycle 202 is illustrated in the sequence diagram of FIG. 2A before the enabled() method is called.

FIGS. 2A and 2B illustrate a life-cycle 204 of an asynchronous request (AJAX) when the proxy XHR object 116 is enabled. Once the original XHR object 114 is replaced by proxy XHR object 116, it is possible to use prototype-based inheritance and override particular methods to allow testing during common XHR life-cycle. First, the test entity 118 112A calls the enable 0 function of the proxy XHR object 116. The methods open() send() and onreadystatechange callback, registered by application 112A, are extended to save attributes passed by application 112A (in case of open() and send() methods) and by original XHR object 114 (e.g., in case of server response handling by calling onreadystatechange). From the application 112A side, the open() method isn't directly invoked on original XHR object 114 instance. Instead, it's invoked on the proxy XHR object 116, which saves the attributes, gives control over to test entity 118 by calling openRequest() method. Once the test entity 118 completes testing of application 112 (on diagram schematically described as call of test() method), it needs to call allowOpen() method to allow further processing of AJAX request. After calling allowOpen(), the proxy XHR object 116 can proceed with calling open() method on original XHR object 114.

A response for open() onreadystatechange callback is triggered by original XHR object 114 with parameter readyState set to 1. Similarly to processing of open() method on proxy XHR object 116, the stateChanged() method is called with the same parameters as the original XHR object's 114 callback invocations, and the test entity 118 can again proceed with testing of application in this state. Next, the test entity 118 calls allowProceed() method to hand over control back to proxy XHR object 116, which calls onreadystatechange callback registered by application on the proxy object 116 with the same parameters as they were passed to original XHR object's callback.

Other situations can be handled similarly to the scenarios described above. For example, callbacks are proceeded in the same manner as described above, while send() method is handled similarly to open() method. In another scenario, a special send, -send() triggers server request and fetches response from server before invoking onreadystatechange callback on the proxy XHR object 116.

In one embodiment, the proxy XHR object 116 is configured to handle two sources of asynchronous communications, including a call to onreadystatechange callback by the server application 112B and calling an open() and send() by the client application 112A. The latter case is caused by asynchronous nature of onreadystatechange callback. Some of browsers don't necessarily call onreadystatechange with readyState equal to 1 or 2, thus it is not possible to wait for these invocations. The onreadystatechange callback may be called asynchronously (based on parameters of the open() method)-open() and send() methods are not blocking. Therefore, before calling stateChanged() method, the proxy XHR object 116 needs to wait for its callback to be called by original XHR object 114.

Also, in the switching context to allow testing, the proxy XHR object 116 needs to synchronize when waiting for allowance to proceed after handing the control over to the test test entity 118. In the depicted embodiment, the test entity 118 is executed on the client computing system 108. In another embodiment, the test entity 118 is executed on another computing system that is external to the client computing system 108. Because testing can be executed by external entity, the proxy XHR object 116 may indicate that testing can be proceeded by calling openRequest(), sendRequest() and stateChanged() methods and expects that on the end of the testing, appropriate method allowing proxy to proceed is called. In another embodiment, it is also possible to implement trivial scenarios where the proxy XHR object itself proceeds with testing.

As described above, there may be three points where the proxy XHR object 116 needs to synchronize communication. In one embodiment, all three cases can be implemented by using built-in window.setTimeout() method with registered callback. This method postpones the further execution and waits for given timeout. When timeouts ends, it calls callback which inspects that any communication has been proceeded and if so, it will continue with execution. In other case, it will again call the window.setTimeout() method with same callback, effectively postponing the execution until reaches suitable conditions (communication has been done, specific testing has ended).

In the depicted embodiment, the life-cycle of the test entity 118 and its test() call marks the point where the test code can continue interaction with the application. The test entity 118 itself may be an JS code which verifies the state of the application and then returns the control the proxy XHR object 116. In one embodiment, the test entity 118 can be some of the browser automation framework. Alternatively, the test entity 118 can be other testing programs as would be appreciated by one of ordinary skill in the art having the benefit of this disclosure.

FIG. 3 is a flow diagram of one embodiment of a client-side method 300 of asynchronous request interception. The method 300 is performed by processing logic that may comprise hardware (circuitry, dedicated logic, etc.), software (such as is run on a general purpose computing system or a dedicated machine), firmware (embedded software), or any combination thereof. In one embodiment, the proxy XHR object 116 of FIGS. 1, 2A, and 2B performs the method 300. Alternatively, other components of the client computing system 108, server computing system 104, or of both can perform some or all of the operations of method 300.

Referring to FIG. 3, processing logic begins with determining whether a proxy object is enabled (block 302). The proxy object is similar to an original object that is used to establish and maintain a network communication interface for an application having a client-side application and a server-side application. The proxy object is configured to allow a test entity to verify the application during a request life-cycle of the asynchronous request. If the proxy object is not enabled, the processing logic processes asynchronous requests using the original object (block 304), and the method ends. However, if at block 302, the proxy object is enabled, the processing logic intercepts the asynchronous request directed to the original object (block 306). Next, the processing logic gives controls to the test entity to verify the application in a current application state (block 308). The test entity verifies the application and then gives back permission to the proxy object. At block 310, the processing logic determines whether permission is received from the test entity. If permission is not received, the processing logic waits until permission is received at block 310. If permission is received at block 310, the processing logic sends the asynchronous request to the original object, which communicates with the server-side application (block 312), and the method 300 ends.

In another embodiment of the method, the processing logic saves attributes passed between the client-side application and the server-side application by the proxy object when the proxy object is enabled. In another embodiment, the test entity is configured to verify progress of the asynchronous request. Using the proxy object to save the attributes being passed extends the functionality of the original object.

In one embodiment at block 306, the processing logic calls, by the client-side application, an open() method from the proxy XHR object, instead of from the original XHR object, to validate and resolve a request() method for the asynchronous request when the proxy XHR object is enabled. The processing logic saves the attributes of the open() method by the proxy XHR object, and gives control to the test entity to further test the application in the current application state. The processing logic receives permission from the test entity to call the open() method from the original XHR object, and the processing logic calls the open() method from the original XHR object when the proxy XHR object receives the permission from the test entity to call the open() method. In a further embodiment, the processing logic receives a response from the open() method from the original XHR object, the response including attributes of an application state. The processing logic saves the attributes of the response, and gives control to the test entity to further test the application in the current application state.

In one embodiment at block 306, the processing logic calls, by the client-side application, a send() method from the proxy XHR object, instead of from the original XHR object, to send the content of the asynchronous request when the proxy XHR object is enabled. The processing logic saves attributes of the send() method and gives control to the test entity to further test the application in the current application state. The processing logic receives permission from the test entity to call the send() method from the original XHR object, and the processing logic calls the send() method from original XHR object when the proxy XHR object receives the permission from the test entity to call the send() method.

In another embodiment of the method, the processing logic creates the XHR object for the asynchronous request, and registers an onreadystatechange event listener for the client-side application to monitor for actions that change a readyState property of the XHR object. The processing logic calls the open() method from the original XHR object to validate and resolve a request() method for the asynchronous request when the proxy XHR object is disabled. The processing logic calls the send() method from the original XHR object to send the contents of the asynchronous request when the proxy XHR object is disabled. In these embodiments, the processing logic receives a response from the server-side application in a form of parameters of onreadystatechange function.

In another embodiment, the asynchronous request is an AJAX request. Alternatively, other types of asynchronous requests may be used. In another embodiment, the original object is an XHR object and the proxy object is a proxy XHR object. In another embodiment, the original object is a websockets object and the proxy object is a proxy websockets object. The proxy websockets object, like the proxy XHR object described herein extends the functionality of the original websockets object. The processing logic then waits to receive permission from the test entity to further process the asynchronous request.

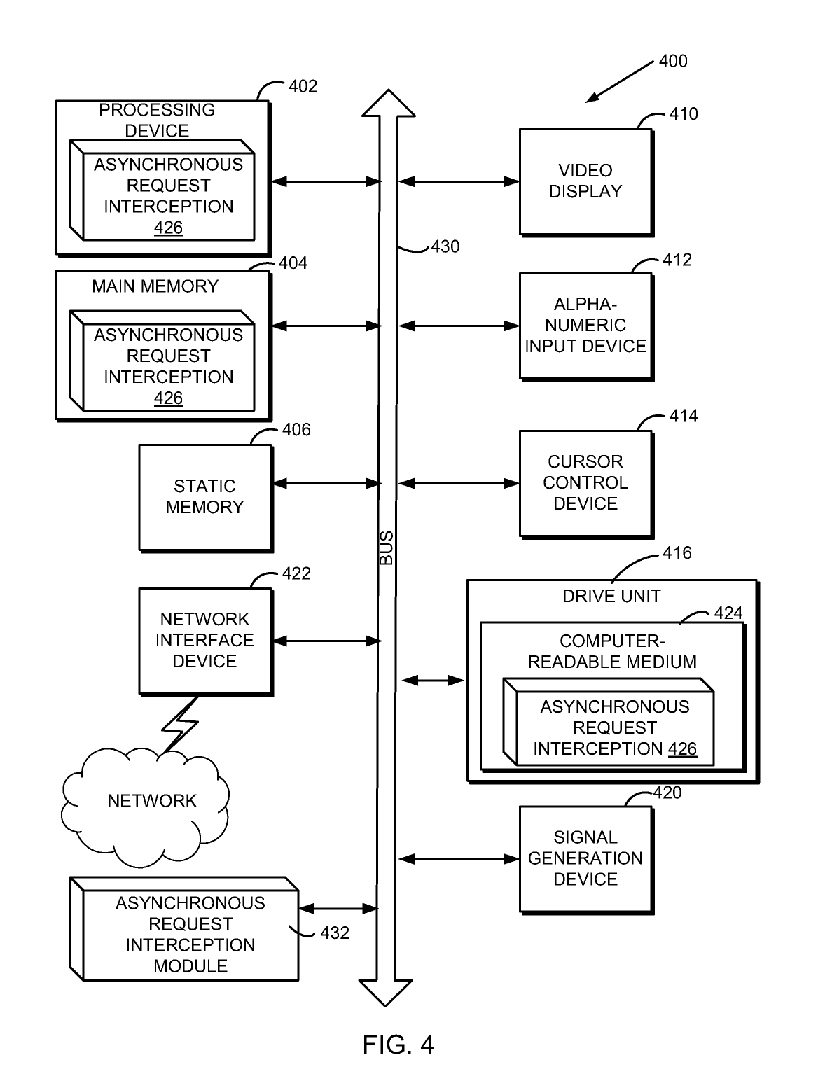

FIG. 4 illustrates a diagrammatic representation of a machine in the exemplary form of a computing system 400 for asynchronous request interception for testing a request life-cycle. Within the computing system 400 is a set of instructions for causing the machine to perform any one or more of the methodologies discussed herein. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a PC, a tablet PC, a set-top-box (STB), a personal data assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein for asynchronous request interception, such as the method 300 described above. In one embodiment, the computing system 400 represents various components that may be implemented in the client computing system 108 as described above. Alternatively, the client computing system 108 may include more or less components as illustrated in the computing system 400. In another embodiment, the computing system 400 represents various components that may be implemented in the server computing system 104.

The exemplary computing system 400 includes a processing device 402, a main memory 404 (e.g., read-only memory (ROM), flash memory, dynamic random access memory (DRAM) such as synchronous DRAM (SDRAM), etc.), a static memory 406 (e.g., flash memory, static random access memory (SRAM), etc.), and a data storage device 416, each of which communicate with each other via a bus 430.

Processing device 402 represents one or more general-purpose processing devices such as a microprocessor, central processing unit, or the like. More particularly, the processing device 402 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 402 may also be one or more special-purpose processing devices such as an application specific integrated circuit (ASIC), a field programmable gate array (FPGA), a digital signal processor (DSP), network processor, or the like. The processing device 402 is configured to execute the processing logic (e.g., asynchronous request interception 426) for performing the operations and steps discussed herein.

The computing system 400 may further include a network interface device 422. The computing system 400 also may include a video display unit 410 (e.g., a liquid crystal display (LCD) or a cathode ray tube (CRT)), an alphanumeric input device 412 (e.g., a keyboard), a cursor control device 414 (e.g., a mouse), and a signal generation device 420 (e.g., a speaker).

The data storage device 416 may include a computer-readable storage medium 424 on which is stored one or more sets of instructions (e.g., asynchronous request interception 426) embodying any one or more of the methodologies or functions described herein. The asynchronous request interception 426 may also reside, completely or at least partially, within the main memory 404 and/or within the processing device 402 during execution thereof by the computing system 400, the main memory 404 and the processing device 402 also constituting computer-readable storage media. The asynchronous request interception 426 may further be transmitted or received over a network via the network interface device 422.

While the computer-readable storage medium 424 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, or other types of mediums for storing the instructions. The term “computer-readable transmission medium” shall be taken to include any medium that is capable of transmitting a set of instructions for execution by the machine to cause the machine to perform any one or more of the methodologies of the present embodiments.

The asynchronous request interception module 432, components, and other features described herein (for example in relation to FIGS. 1-3) can be implemented as discrete hardware components or integrated in the functionality of hardware components such as ASICS, FPGAs, DSPs, or similar devices. The asynchronous request interception module 432 may implement operations of asynchronous request interception as described herein with respect to FIGS. 4A and 4B. In addition, the asynchronous request interception module 432 can be implemented as firmware or functional circuitry within hardware devices. Further, the asynchronous request interception module 432 can be implemented in any combination hardware devices and software components.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to utilize the invention and various embodiments with various modifications as may be suited to the particular use contemplated.

What is claimed is:

1. A method, implemented by a client computing system programmed to perform the following, comprising:
intercepting, by a proxy object executing on the client computing system, an asynchronous request directed to an original object used to implement a network communication interface for an application comprising a client-side application executing on the client computing system and a server-side application executing on a server computing system, wherein the proxy object is configured to allow a test entity to verify the application during a request life-cycle of the asynchronous request;
giving control to the test entity to verify the application in a current application state;
receiving permission from the test entity to further process the asynchronous request; and
sending, by the proxy object, the asynchronous request to the original object when the proxy object receives the permission.

2. The method of claim 1, wherein the asynchronous request is an asynchronous JavaScript and XML (AJAX) request.

3. The method of claim 1, further comprising saving attributes passed between the client-side application and the server-side application by the proxy object when the proxy object is enabled.

4. The method of claim 1, wherein the test entity is configured to verify progress of the asynchronous request.

5. The method of claim 1, wherein the original object is an XMLHttpRequest (XHR) object and the proxy object is a proxy XHR object.

6. The method of claim 1, wherein the original object is a websockets object and the proxy object is a proxy websockets object.

7. The method of claim 5, wherein said intercepting comprises:
calling, by the client-side application, an open() method from the proxy XHR object, instead of from the original XHR object, to validate and resolve a request() method for the asynchronous request when the proxy XHR object is enabled;
saving attributes of the open() method of the asynchronous request by the proxy XHR object; and
giving control to the test entity to further test the application in the current application state,
wherein said receiving permission from the test entity comprises receiving permission from the test entity to call the open() method from the original XHR object, and
wherein said sending the asynchronous request comprises calling, by the proxy XHR object, the open() method from the original XHR object when the proxy XHR object receives the permission from the test entity to call the open() method.

8. The method of claim 7, further comprising:
receiving, by the proxy XHR object, a response for the open() method from the original XHR object, the response comprising attributes of the current application state;
saving the attributes of the response by the proxy XHR object;
giving control to the test entity to further test the application in the current application state; and
receiving permission from the test entity to further process the asynchronous request.

9. The method of claim 5, wherein said intercepting comprises:
calling, by the client-side application, a send() method from the proxy XHR object, instead of from the original XHR object, to send content of the asynchronous request when the proxy XHR object is enabled; and
saving attributes of the send() method of the asynchronous request by the proxy XHR object; and
giving control to the test entity to further test the application in the current application state,
wherein said sending the asynchronous request comprises receiving permission from the test entity to call the send() method from the original XHR object, and
wherein said sending the asynchronous request comprises calling, by the proxy XHR object, the send() method from the original XHR object when the proxy XHR object receives the permission from the test entity to call the send() method.

10. The method of claim 5, further comprising:
creating the XHR object for the asynchronous request;
registering an onreadystatechange event listener for the client-side application to monitor for actions that change a readyState property of the XHR object;
calling, by the client-side application, an open() method from the original XHR object to validate and resolve a request() method for the asynchronous request when the proxy XHR object is disabled;
calling, by the client-side application, a send() method of the original XHR to send content of the asynchronous request when the proxy XHR object is disabled; and
receiving a response from the server-side application in a form of parameters of onreadystatechange function.

11. The method of claim 1, wherein the client computing system comprises a JavaScript (JS) runtime machine to execute the client-side application, the test entity, the proxy object, and the original object, and wherein the test entity is a JS test object to verify the current application state during the request life-cycle of the asynchronous request.

12. The method of claim 1, wherein the test entity is executed on another computing system.

13. The method of claim 1, wherein the client-side application and the server-side application form a web application, hosted by the server computing system, and wherein the client-side application is a browser application.

14. A non-transitory computer readable storage medium including instructions that, when executed by a client computing system, cause the computing system to perform a method comprising:
intercepting, by a proxy object executing on the client computing system, an asynchronous request directed to an original object used to implement a network communication interface for an application comprising a client-side application executing on the client computing system and a server-side application executing on a server computing system, wherein the proxy object is configured to allow a test entity to verify the application during a request life-cycle of the asynchronous request;
giving control to the test entity to verify the application in a current application state;
receiving permission from the test entity to further process the asynchronous request; and
sending, by the proxy object, the asynchronous request to the original object when the proxy object receives the permission.

15. The computer readable storage medium of claim 14, wherein the method further comprises saving attributes passed between the client-side application and the server-side application by the proxy object when the proxy object is enabled.

16. The computer readable storage medium of claim 14, wherein the original object is an XMLHttpRequest (XHR) object and the proxy object is a proxy XHR object.

17. The computer readable storage medium of claim 14, wherein the original object is a websockets object and the proxy object is a proxy websockets object.

18. The computer readable storage medium of claim 16, wherein said intercepting comprises:
calling, by the client-side application, an open() method from the proxy XHR object, instead of from the original XHR object, to validate and resolve a request() method for the asynchronous request when the proxy XHR object is enabled;
saving attributes of the open() method of the asynchronous request by the proxy XHR object; and
giving control to the test entity to further test the application in the current application state,
wherein said receiving permission from the test entity comprises receiving permission from the test entity to call the open() method from the original XHR object, and
wherein said sending the asynchronous request comprises calling, by the proxy XHR object, the open() method from the original XHR object when the proxy XHR object receives the permission from the test entity to call the open() method.

19. The computer readable storage medium of claim 18, wherein the method further comprises:
receiving, by the proxy XHR object, a response for the open() method from the original XHR object, the response comprising attributes of the current application state;
saving the attributes of the response by the proxy XHR object;
giving control to the test entity to further test the application in the current application state; and
receiving permission from the test entity to further process the asynchronous request.

20. The computer readable storage medium of claim 16, wherein said intercepting comprises:
calling, by the client-side application, a send() method from the proxy XHR object, instead of from the original XHR object, to send content of the asynchronous request when the proxy XHR object is enabled; and
saving attributes of the send() method of the asynchronous request by the proxy XHR object; and
giving control to the test entity to further test the application in the current application state,
wherein said sending the asynchronous request comprises receiving permission from the test entity to call the send() method from the original XHR object, and
wherein said sending the asynchronous request comprises calling, by the proxy XHR object, the send() method from the original XHR object when the proxy XHR object receives the permission from the test entity to call the send() method.

21. A client computing system, comprising:
a data storage device; and
a processing device, coupled to the data storage device, to execute a proxy object, wherein the proxy object is configured to:
intercept an asynchronous request directed to an original object used to maintain a network communication interface for an application comprising a client-side application executing on the client computing system and a server-side application executing on a server computing system, wherein the proxy object is configured to allow a test entity to verify the application during a request life-cycle of the asynchronous request;
give control to the test entity to verify the application in a current application state;
receiving permission from the test entity to further process the asynchronous request; and
send the asynchronous request to the original object when the permission is received.

22. The client computing system of claim 21, further comprising a JavaScript (JS) runtime machine to execute on the processing device, wherein the test entity is a JS test object to be executed by the JS runtime machine to verify the current application state during the request life-cycle of the asynchronous request.

23. The client computing system of claim 21, wherein the client computing system is communicatively coupled to another computing system configured to execute the test entity.

24. The client computing system of claim 21, wherein the original object is an XMLHttpRequest (XHR) object and the proxy object is a proxy XHR object.

25. The client computing system of claim 21, wherein the original object is a websockets object and the proxy object is a proxy websockets object.
